(19) United States
(12) Patent Application Publication
(10) Pub. No.: US 2020/0266888 A1
(43) Pub. Date: Aug. 20, 2020

(54) OPTICAL COMMUNICATION APPARATUS, OPTICAL TRANSMISSION SYSTEM, AND OPTICAL COMMUNICATION METHOD

(71) Applicant: FUJITSU LIMITED, Kawasaki-shi (JP)

(72) Inventors: Yohei Koganei, Kawasaki (JP); KAZUMASA MIKAMI, Yokohama (JP); Shigeyuki KOBAYASHI, Ashikaga (JP); Mitsuru SUTOU, Sano (JP); Yuji OBANA, Shimotsuga (JP)

(73) Assignee: FUJITSU LIMITED, Kawasaki-shi (JP)

(21) Appl. No.: 16/750,907

(22) Filed: Jan. 23, 2020

(30) Foreign Application Priority Data
Feb. 15, 2019 (JP) 2019-025914

(51) Int. Cl. H04B 10/079; H04L 1/00; H04J 14/06; H04B 10/2507

(52) U.S. Cl. CPC H04B 10/07953; H04B 10/2572; H04J 14/06; H04L 1/0047

(57) ABSTRACT

An optical communication apparatus includes a first monitor that monitors a first signal carried on a first polarization and outputs a first monitor value representing a transmission characteristic of the first signal, a second monitor that monitors a second signal carried on a second polarization orthogonal to the first polarization and outputs a second monitor value representing a transmission characteristic of the second signal, and a transmitting circuit that notifies a transmitting source of the first signal and the second signal of the first monitor value and the second monitor value.

### CROSS-REFERENCE TO RELATED APPLICATION

This application is based upon and claims the benefit of priority of the prior Japanese Patent Application No. 2019-25914, filed on Feb. 15, 2019, the entire contents of which are incorporated herein by reference.

### FIELD

The embodiments discussed herein are related to an optical communication apparatus, an optical transmission system, and an optical communication method.

### BACKGROUND

With the increasing demand for communication, optical communication using a digital coherent scheme is growing in prevalence to achieve high-speed and large-capacity communication. The digital coherent scheme enables long-distance and large-capacity transmission by utilizing the properties of light waves. Using phase information of light waves allows the information amount to be doubled as compared with an intensity modulation/direct direction scheme. Furthermore, utilizing dual polarization (DP), in which information is carried on two orthogonal polarizations, causes the information amount to be four times the information amount of the intensity modulation/direct direction scheme.

In dual polarization digital coherent transmission, there is a difference in the characteristics, such as a signal-to-noise ratio (SNR), due to a polarization dependent loss (PDL) between polarizations in some cases. There are some cases where the PDL changes over time because of a change in the physical orientations or arrangement of optical components on an optical transmission path. Degradation in the SNR decreases the spectral efficiency to increase a gap to theoretical communication capacity (Shannon capacity).

To bring high-speed transmission close to Shannon capacity, probabilistic shaping, which shapes the probability distribution of modulation symbols in a quadrature amplitude modulation (QAM) scheme, has been proposed (refer to, for example, Fred Buchali, et al., “Rate Adaption and Reach Increase by Probabilistically Shaped 64-QAM: An Experimental Demonstration”, Journal of Lightwave Technology, Vol. 34, No. 7, Apr. 1, 2016.). Use of normalized generalized mutual information (NGMI) as a forward error correction threshold for probabilistically shaped QAM symbols has been proposed (refer to, for example, Junho Cho, Laurent Schmalen, Peter J. Winzer, “Normalized Generalized Mutual Information as a Forward Error Correction Threshold for Probabilistically Shaped QAM”, 2017 European Conference on Optical Communication (ECOC), 17-21 Sep. 2017). The NGMI may be an index indicating the decoding performance of an error correction code.

### SUMMARY

According to an aspect of the embodiments, an optical communication apparatus includes a first monitor that monitors a first signal carried on a first polarization and outputs a first monitor value representing a transmission characteristic of the first signal, a second monitor that monitors a second signal carried on a second polarization orthogonal to the first polarization and outputs a second monitor value representing a transmission characteristic of the second signal, and a transmitting circuit that notifies a transmitting source of the first signal and the second signal of the first monitor value and the second monitor value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating technical problems in dual polarization coherent transmission;

FIG. 2 is a diagram illustrating a basic configuration of an embodiment;

FIG. 3 includes conceptual diagrams for probabilistic shaping;

FIG. 4 is a block diagram of a receiving-end digital signal processing circuit of an optical communication apparatus according to an embodiment;

FIG. 5 is a diagram illustrating calculation of NGMI with an NGMI monitor;

FIG. 6 is a block diagram of a transmitting-end digital signal processing circuit of an optical communication apparatus according to an embodiment;

FIG. 7 is a diagram that plots the values of NGMI of cases where there is a difference in SNR between an H polarization and a V polarization;

FIG. 8 is a modification of a transmitting-end digital signal processing circuit;

FIG. 9 is a schematic view of an output data format of a distribution matcher;

FIG. 10 is a diagram illustrating effects of a configuration of an embodiment;

FIG. 11 is a block diagram illustrating an example of another configuration of a receiving-end digital signal processing circuit;

FIG. 12 is a block diagram illustrating an example of still another configuration of a receiving-end digital signal processing circuit;

FIG. 13 is a block diagram illustrating an example of still another configuration of a receiving-end digital signal processing circuit; and

FIG. 14 is a block diagram of a transmitting-end digital signal processing circuit corresponding to a receiving-end digital signal processing circuit illustrated in FIG. 13.

### DESCRIPTION OF EMBODIMENTS

In dual polarization digital coherent transmission, when the difference in characteristics between polarizations is large, in some cases, communication continues while the difference in SNR between a horizontal (H) polarization and a vertical (V) polarization is kept maximum at an optical-signal receiving end due to PDL or the like. In many cases, signals carried on the H polarization and signals carried on the V polarization are interleaved and are subjected to an error correction process. However, whether a decoding process is successful largely depends on the polarization with a poor SNR. On the assumption that the situation is worst, the transmission path is designed with a margin; however, when the signal quality of the polarization with a good SNR has a margin, this margin is not utilized.

Although it is conceivable to use polarization scrambling to distribute the effects of PDL between the H polarization and to the V polarization, this has no effects on improving NGMI. In addition, in cases where the difference in characteristics between polarizations results from characteristics variations among electrical components through which signals of each polarization pass, such a difference is hard to be dealt with by polarization scrambling.

The present disclosure effectively utilizes the bandwidth of each polarization even in an environment where the difference in characteristics between polarizations may occur, and improves the transmission performance of optical communication.

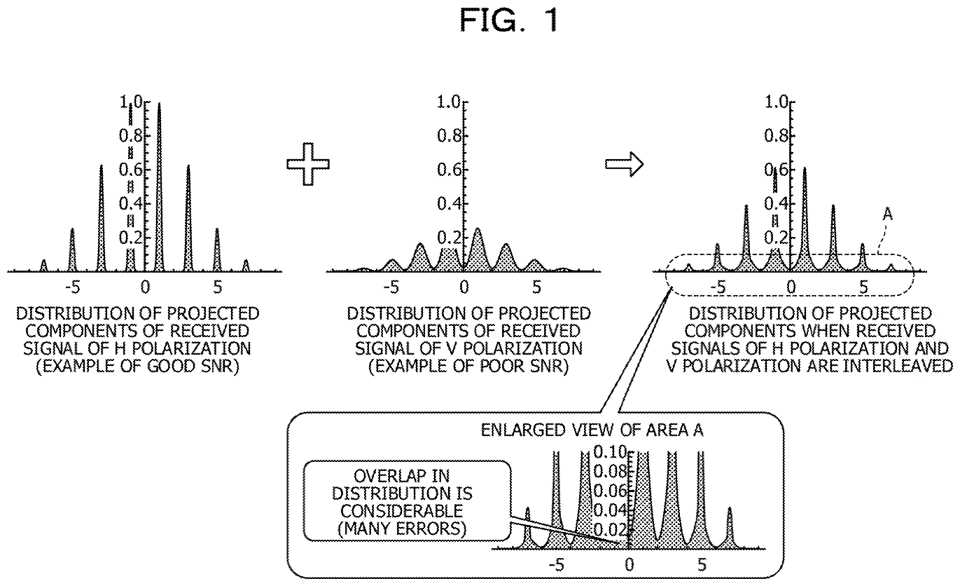

FIG. 1 is a diagram illustrating in more detail technical problems in dual polarization digital coherent transmission. When, for example, due to PDL, the SNR of the H polarization is good but the SNR of the V polarization is poor, projected components of a received signal of the H polarization are distributed with steep peaks, and projected components of a received signal of the V polarization are distributed with small peaks and a large overlap between symbols. The projected components as used herein are components obtained by projecting the probability distribution of received symbols on the IQ plane onto the I-axis or the Q-axis. Although the halftone area of the H polarization and the halftone area of the V polarization have the same size, the shape of distribution of projected components of a received signal largely varies depending on the characteristics of polarization.

When received signals of the H polarization and the V polarization are interleaved for the purpose of an error correction process, the distribution is such that the projected components of a received signal of the H polarization and the projected components of a received signal of the V polarization are averaged. The distributions of projected components overlap in an area with a low frequency in the projected spectrum, and therefore it is difficult to correctly divide received signals, leading to an error increase. When the signal quality of the H polarization with a good SNR has a margin, it is difficult to utilize this.

To solve this problem, in an embodiment, for each of a signal received on the X polarization and a signal received on the Y polarization, index values representing the decoding performance are individually monitored at the receiving end. The index values representing decoding performances are NGMI, Q value, pre-forward error correction bit error rate (pre-FEC bit error rate (BER)), and the like. In accordance with monitor results, effective information rates (IRs) are set separately for the H polarization and the V polarization.

For example, in the case of a poor monitor value, decreasing the IR improves the noise immunity or transmission performance. In the case of a good monitor value, increasing the IR improves the transmission efficiency. A configuration in which while the total information rate (IR) for the H polarization and the V polarization remains fixed, the data rate of each of the H polarization and the V polarization is changed may be employed. Such processes performed at the receiving end may be performed upon coupling establishment or during operation.

The monitor result at the receiving end may be fed back to the transmitter side. In this case, based on feedback information at the transmitting end, entropy (information amount) may be set separately for respective transmitted signals of the H polarization and of the V polarization and probabilistic shaping may be performed. Reflecting a monitor result on the probabilistic shaping on the transmitter side allows a change in signal quality, which changes over time, to be dealt with. Based on a monitor result, the sum of information rates of polarizations may be controlled most suitably on the transmitter side.

<Basic Configuration>

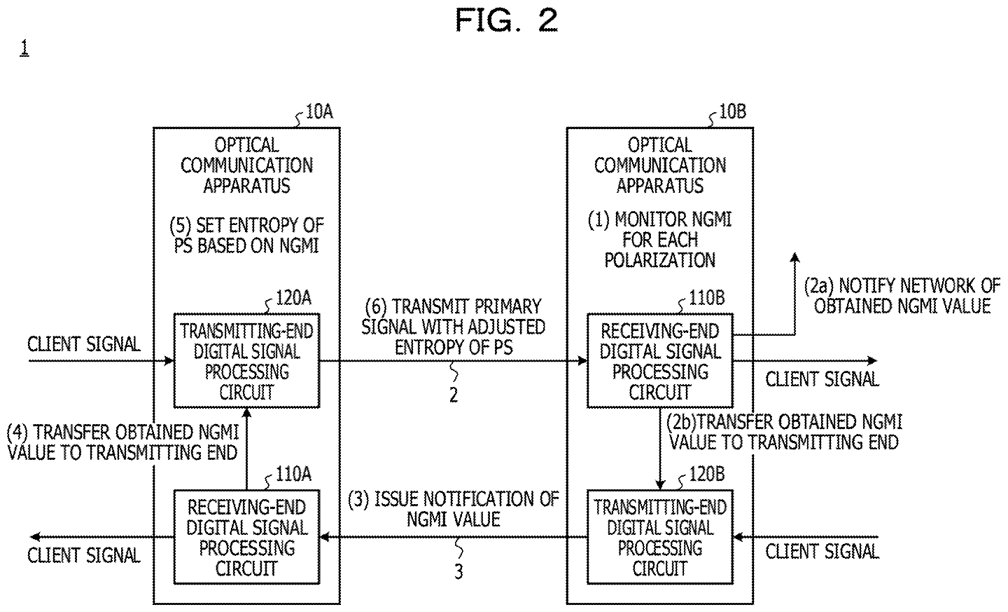

FIG. 2 is a diagram illustrating a basic configuration of an embodiment. An optical transmission system 1 includes a first optical communication apparatus 10A, a second optical communication apparatus 10B, and optical transmission paths 2 and 3 coupled therebetween. The optical communication apparatus 10A includes a receiving-end digital signal processing circuit 110A and a transmitting-end digital signal processing circuit 120A, and transmits and receives optical signals. The optical communication apparatus 10B includes a receiving-end digital signal processing circuit 110B, a transmitting-end digital signal processing circuit 120B and transmits and receives optical signals. The case where a network signal is transmitted from the optical communication apparatus 10A to the optical communication apparatus 10B will be described below as an example.

The receiving-end digital signal processing circuit 110B of the optical communication apparatus 10B monitors, for each polarization, the NGMI of a signal received from the optical transmission path 2 and demodulated (step (1)). NGMI is one of indexes indicating signal quality, such as decoding performance, and another index value, such as a Q value or Pre-FEC BER, may be monitored instead of NGMI.

NGMI is information in which mutual information in the field of information theory is applied to optical communication, and is expressed as NGMI=1−(H(X)−GMI)/m, where H(X) is entropy (information amount) in information theory with a transmission symbol X being a variable, GMI is generalized mutual information, and m is the modulation multilevel (or the number of bits). NGMI is a normalized value and has a possible maximum value of one. The greater the NGMI value, the higher the decoding accuracy of an error correction code. A specific method for calculating NGMI will be described later.

The obtained NGMI value is fed back to the optical communication apparatus 10A. The feedback mechanism may have a configuration of notifying a control device on a network of the obtained NGMI value (step (2a)), or a configuration of transferring the obtained NGMI value to the transmitting end of the optical communication apparatus 10B (step (2b)) and issuing a notification from the transmitting end to the optical communication apparatus 10A.

If a control device on a network is notified of the monitored NGMI value, an information rate (IR) that is effective on the network may be set based on the monitor value. The effective information rate is the proportion of a useful data stream, and if the code rate is k/n, information of a total of n symbols is generated for every k bits of useful data.

The NGMI value transferred to the transmitting end is transmitted to the optical communication apparatus 10A via the optical transmission path 3 by the transmitting-end digital signal processing circuit 120B (step (3)). The NGMI value of which the optical communication apparatus 10A is notified may be transmitted in such a manner as to be included in optical-channel transport unit overhead (OTU OH) or supervisory (SV) light or may be embedded in a data signal as described later.

The receiving-end digital signal processing circuit 110A of the optical communication apparatus 10A transfers the received NGMI value to the transmitting-end digital signal processing circuit 120A (step (4)).

The transmitting-end digital signal processing circuit 120A sets entropy of probabilistic shaping (appropriately abbreviated as PS hereinafter) based on NGMI (step (5)). PS, which is one of the optical signal processing methods using multilevel modulation, is a technique of intentionally giving a probability distribution to a set of a finite number of discrete transmitted symbols.

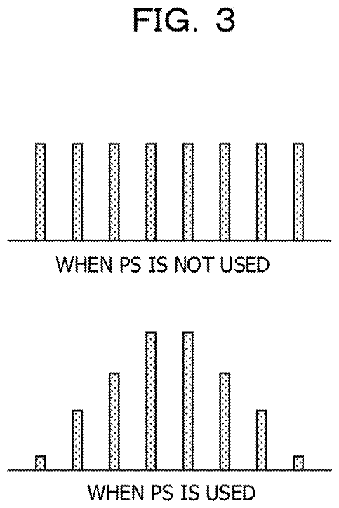

FIG. 3 includes conceptual diagrams for PS. For convenience of illustration, the diagrams are depicted in the form of histograms of projected components onto the I-axis or the Q-axis on the IQ plane. In reality, three-dimensional probability distribution is provided in which the histogram is distributed in a direction perpendicular to the IQ plane for each of constellation points on uniform grids on the IQ plane. In this sense, PS is referred to as probabilistic constellation shaping in some cases.

When PS is not applied, in digital coherent transmission, constellation points have a uniform probability distribution on the IQ plane. When PS is applied, for a set of transmission symbols, there are many cases where the distribution is matched with a normal distribution with a maximum value at the center on the IQ plane. At this point, changing the variance of the normal distribution allows an effective information rate to be set with a fine granularity. NGMI monitored on the receiver side is a unified index that accurately indicates the decoding performance of an error correction code regardless of whether PS is applied.

Decreasing an effective information rate causes the probability distribution of constellation points to be a sharp normal distribution with a high frequency at the center of modulation symbols, such that the noise immunity improves.

Referring now to FIG. 2, the primary signal to which PS with the adjusted entropy is applied is transmitted to the optical communication apparatus 10B via the optical transmission path 2 (step (6)).

In the case where an optical signal is transmitted from the optical communication apparatus 10B to the optical communication apparatus 10A, the same process as described above is performed. When the process described above is performed during operation, in parallel with the process described above, network signals are transmitted and received between the optical communication apparatus 10A and the optical communication apparatus 10B, and client signals decoded by the receiving-end digital signal processing circuits 110A and 110B are output to the client side. Client signals input to the transmitting-end digital signal processing circuits 120A and 120B are then converted into the frame format of the network side and are output to the optical transmission paths 2 and 3.

When the process described above is performed during non-operation, such as upon coupling establishment, an information rate suitable for PS may be set by monitoring NGMI with a test signal, such as a pseudo random bit sequence.

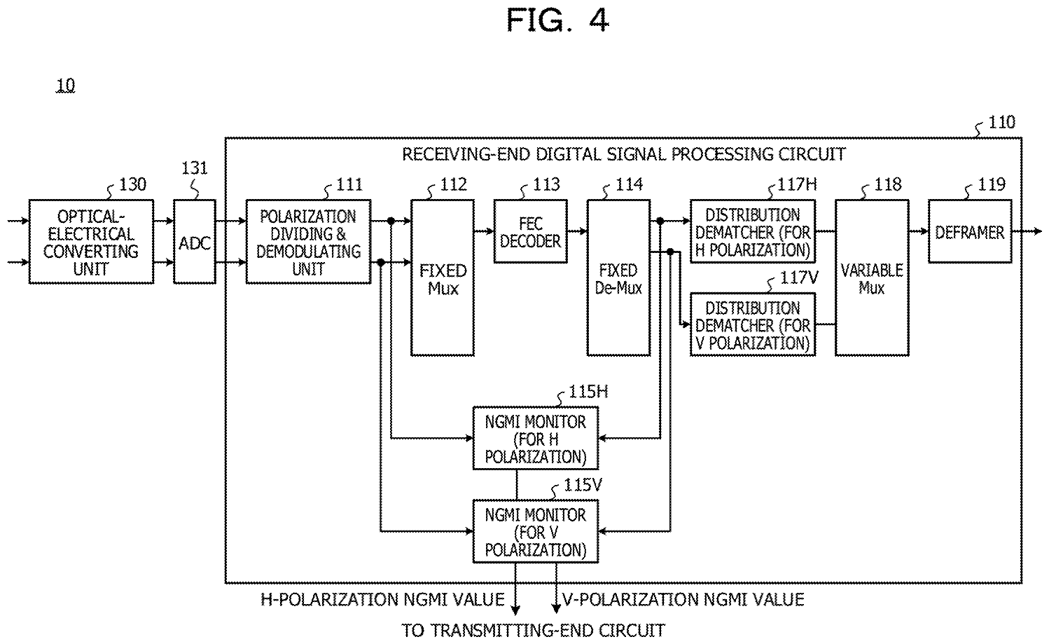

FIG. 4 is a block diagram of the receiving-end digital signal processing circuit 110 of the optical communication apparatus 10. The receiving-end digital signal processing circuit 110 includes a polarization dividing and demodulating unit 111, a fixed multiplexer (in the drawings, denoted by Mux) 112, an FEC decoder 113, a fixed demultiplexer (in the drawings, denoted by De-Mux) 114, an H-polarization NGMI monitor 115H, and a V-polarization NGMI monitor 115V. The receiving-end digital signal processing circuit 110 further includes an H-polarization distribution dematcher 117H, a V-polarization distribution dematcher 117V, a variable multiplexer 118, and a deframer 119. The distribution dematchers 117H and 117V have a function of performing inverse distribution matching and perform a process of returning symbols whose intensity distribution is probabilistically shaped, into a sequence of data bits prior to the shaping.

Optical signals received from the optical transmission path 2 or 3 are converted into electrical signals by an optical-electrical converting unit 130 of the optical communication apparatus 10, are digitally sampled by an analog-to-digital converter (ADC) 131, and are input to the receiving-end digital signal processing circuit 110.

The input digital electrical signals are divided into a received signal of the H polarization and a received signal of the V polarization and are demodulated or demapped by the polarization dividing and demodulating unit 111. The demodulated received signal of the H polarization and received signal of the V polarization are input to the fixed multiplexer 112 and are also fed respectively to the H-polarization NGMI monitor 115H and the V-polarization NGMI monitor 115V.

By the fixed multiplexer 112, the received signal of the H polarization and the received signal of the V polarization are combined together according to a fixed allocation ratio, and the resultant signal is subjected to forward error correction and decoding by the FEC decoder 113. The signal after being subjected to the error correction and decoding is divided according to the fixed allocation ratio into an H-polarization component and a V-polarization component by the fixed demultiplexer 114, which are input respectively to the H-polarization distribution dematcher 117H and the V-polarization distribution dematcher 117V. The respective polarization components after being subjected to the error correction are also fed to the H-polarization NGMI monitor 115H and the V-polarization NGMI monitor 115V.

The respective polarization components after being subjected to the error correction that are input to the H-polarization distribution dematcher 117H and the V-polarization distribution dematcher 117V are restored to sequences of data bits in accordance with the percentages of information rates assigned respectively to the H polarization and the V polarization. These processes are inverse conversion of the processes performed by an H-polarization distribution matcher 123H and a V-polarization distribution matcher 123V described later. The restored bit sequences are multiplexed by the variable multiplexer 118, are converted into the frame format of the client side by the deframer 119, and are output.

Meanwhile, the polarization components fed to the H-polarization NGMI monitor 115H and the V-polarization NGMI monitor 115V are used for calculation of NGMI.

The H-polarization NGMI monitor 115H has two inputs and one output. One input of the H-polarization NGMI monitor 115H receives a signal of the H polarization divided and demodulated by the polarization dividing and demodulating unit 111, and the other input receives the H-polarization component divided by the fixed demultiplexer 114.

The signal of the H polarization fed from the polarization dividing and demodulating unit 111 is received bits before being subjected to error correction. The H-polarization component fed from the fixed demultiplexer 114 is error-corrected and decoded data and may be regarded as expected data that matches transmission data with the H polarization. The H-polarization NGMI monitor 115H calculates NGMI of the H polarization based on the received data and the expected data (transmission data) and outputs the calculated NGMI value.

The V-polarization NGMI monitor 115V has two inputs and one output. One input of the V-polarization NGMI monitor 115V receives a signal of the V polarization divided and demodulated by the polarization dividing and demodulating unit 111, and the other input receives the V-polarization component divided by the fixed demultiplexer 114.

The signal of the V polarization fed from the polarization dividing and demodulating unit 111 is received bits before being subjected to error correction. The V-polarization component fed from the fixed demultiplexer 114 is error-corrected and decoded data and may be regarded as expected data that matches transmission data with the V polarization. The V-polarization NGMI monitor 115V calculates NGMI of the V polarization based on the received data and the expected data (decoded transmission data) and outputs the calculated NGMI value.

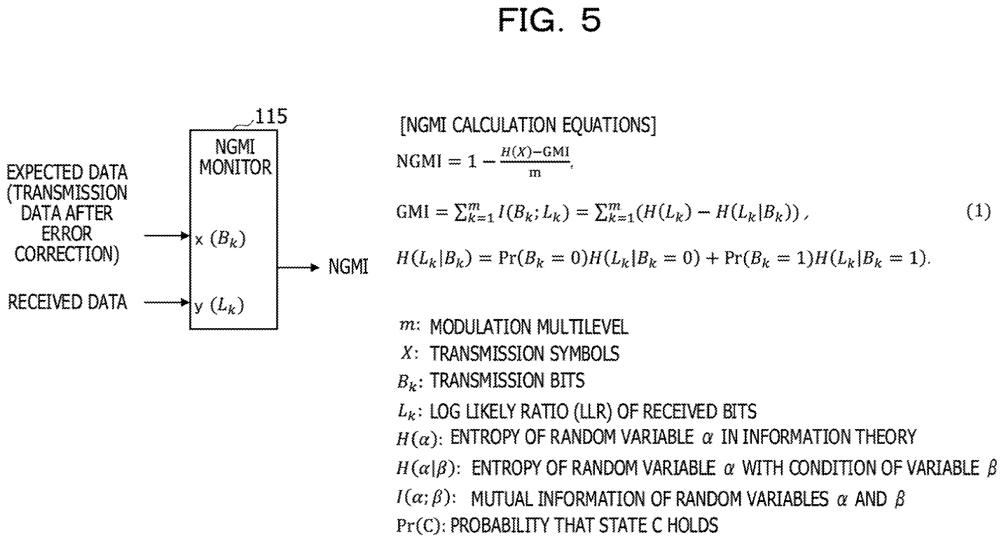

FIG. 5 is a diagram illustrating calculation of NGMI with the NGMI monitor 115. The received data before being subjected to error correction is input to one input terminal of the NGMI monitor 115, and the log likelihood ratio (LLR) of a received bit, Lk, is obtained. The expected data, that is, data decoded by error correction is input to the other input terminal of the NGMI monitor 115, and transmission bits Bk are obtained. NGMI is obtained by equations (1).

$$NGMI = 1 - \frac{H ( X ) - GMI}{m} , \\ GMI = {\sum }_{k = 1}^{m} I ( {B}_{k} ; {L}_{k} ) = {\sum }_{k = 1}^{m} ( H ( {L}_{k} ) - H ( {L}_{k } \vert {B}_{k} ) ) , \\ H ( {L}_{k} \vert {B}_{k} ) = Pr ( {B}_{k} = 0 ) H ( {L}_{k} \vert {B}_{k} = 0 ) + Pr ( {B}_{k} = 1 ) H ( {L}_{k} \vert {B}_{k} = 1 ) . \qquad ( 1 )$$

where m is a modulation multilevel, X is transmission symbols, Bk is transmission bits assigned to the kth multilevel, Lk is a log likelihood ratio (LLR) of received bits assigned to the kth multilevel, H(α) is entropy of a random variable α in information theory, H(α|β) is entropy of the random variable α with the condition of a variable β, I(α; β) is mutual information of random variables α and β, and Pr(C) is the probability that the state C holds.

In equations (1), H(X) is the entropy (information amount) of transmission symbols X, and GMI is the sum total of mutual information of transmission bits Bk and LLR (Lk) of received bits. The value that the kth transmission bit Bk may have is “0” or “1”, and the sum of the probability (Pr(Bk=0)) that Bk=0 holds and the probability (Pr(Bk=1)) that Bk=1 holds is one.

NGMI is obtained by subtracting, from one, a value given by dividing the difference between the entropy H(X) of transmission symbols X and GMI by the modulation multilevel m. The smaller the difference between the entropy H(X) of transmission symbols X and GMI, the closer NGMI becomes to one and the higher the SNR is.

By the H-polarization NGMI monitor 115H and the V-polarization NGMI monitor 115V, the NGMI values are obtained for the H polarization and the V polarization, respectively. The obtained NGMI values are transmitted to a network control apparatus or an optical communication apparatus on the partner side.

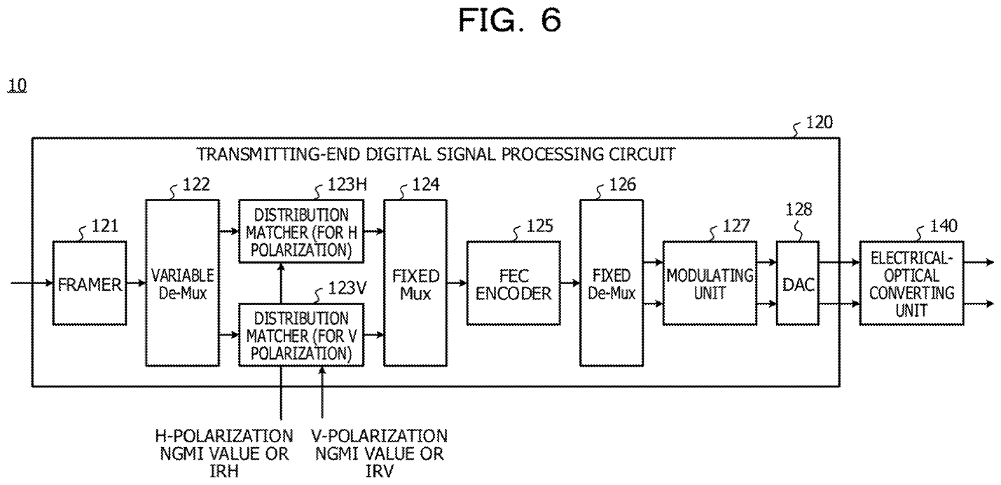

FIG. 6 is a block diagram of the transmitting-end digital signal processing circuit 120 of the optical communication apparatus 10. The transmitting-end digital signal processing circuit 120 includes a framer 121, a variable demultiplexer 122, the H-polarization distribution matcher 123H, the V-polarization distribution matcher 123V, a fixed multiplexer 124, an FEC encoder 125, a fixed demultiplexer 126, a modulating unit 127, and a digital-to-analog converter (DAC) 128. The distribution matcher 123 has a function of performing transformation processing of distribution matching as described in “Rate Adaption and Reach Increase by Probabilistically Shaped 64-QAM: An Experimental Demonstration”, and shapes the intensity distribution of the sequence of data bits to transform the sequence of bits into the sequence of symbols with non-uniform intensity distribution.

The framer 121 converts a signal input from the client side into the frame format of the network side. The format-converted signal is divided into an H-polarization signal component and a V-polarization signal component by the variable demultiplexer 122, which are input respectively to the H-polarization distribution matcher 123H and the V-polarization distribution matcher 123V.

An NGMI value for the H polarization transmitted from the optical communication apparatus 10 on the partner side or an information rate (IR_{H}) set based on the NGMI value is input to the H-polarization distribution matcher 123H. An NGMI value for the V polarization transmitted from the optical communication apparatus 10 on the partner side or an information rate (IR_{V}) set based on the NGMI value is input to the V-polarization distribution matcher 123V.

The information rates IR_{H} and IR_{V} may be rates set based on the transmitted NGMI values by the optical communication apparatus 10 or may be rates set based on NGMI monitor values by a control device on a network.

The distribution matchers 123H and 123V adjust the degrees of shaping of PS based on the NGMI values or the information rates, and adjust the probability distribution of transmission symbols on the IQ plane for each polarization. When the NGMI value is small (a poor SNR due to the influence of PDL and so on), the information rate is decreased, so that a steeper probability distribution than in usual QAM symbol transmission having a uniform probability distribution is generated. Thus, the noise immunity improves.

By “decreasing the IR”, it is meant that the probability distribution of symbols in the constellation is shaped into a sharp normal distribution with a high frequency at the origin or the center of modulation. When the NGMI value is small, the degree of shaping is increased, such that data of a signal point close to the origin of the constellation plane is transmitted at a high frequency and the frequency at which data of other signal points are transmitted is decreased. Thus, the signal quality is optimized.

When the NGMI value is large (a good SNR with less influence of PDL and so on), the degree of shaping is decreased, so that a more uniform probability distribution is achieved to increase the information rate. Thus, the use efficiency of signal components of a polarization in a good state increases.

The respective signal components of polarizations with the shaped probability distributions are combined by the fixed multiplexer 124, and the resultant signal is subjected to error correction encoding by the FEC encoder 125. The signal encoded with error correction code is again divided into the H-polarization component and the V-polarization component by the fixed demultiplexer 126, and is mapped onto electric field information (phase and amplitude) for each polarization component by the modulating unit 127. The digital signal mapped onto the electric field information is converted into an analog signal by the DAC 128 and the analog signal is input to an electrical-optical converting unit 140.

The electrical-optical converting unit 140 may have a known configuration and, for example, includes a modulator driver that generates a high-speed drive signal from an analog signal, an optical modulator, a light source, and so on. Light incident on the optical modulator is modulated by an electrical signal input from the modulator driver so that the phase and amplitude of the light are in accordance with the logic value of input data, and the light is output to the optical transmission path 2 or 3.

With such a configuration of the optical communication apparatus 10, if a difference in characteristics between polarizations is generated because of the influence of PDL and so on, the bandwidth of each polarization may be effectively utilized.

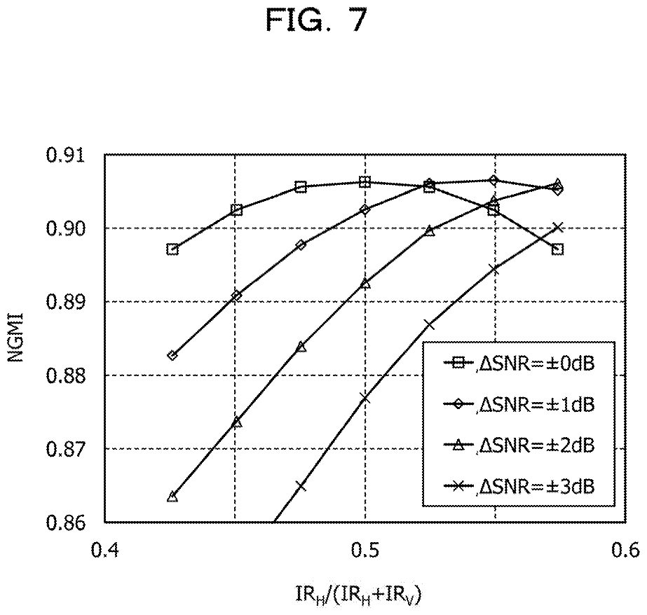

FIG. 7 is a diagram that plots the values of NGMI of cases where there is a difference in SNR between the H polarization and the V polarization. The horizontal axis is the ratio between the information rate of the H polarization and the information rate of the V polarization (IR_{H}/(IR_{H}+IR_{V})), representing an allocation of information rates in probabilistic shaping.

The difference in SNR (ΔSNR) is represented as a difference from the reference SNR, and simulations are performed with four differences of ±0 dB, ±1 dB, ±2 dB, and ±3 dB. The reference SNR is assumed to be 8.8 dB, and the transmission path is modeled by an adaptive white Gaussian noise (AWGN) channel.

When ΔSNR=±0 dB, SNR_{H}=8.8 dB and SNR_{V}=8.8 dB.

When ΔSNR=±1 dB, SNR_{H}=9.8 dB and SNR_{V}=7.8 dB.

When ΔSNR=±2 dB, SNR_{H}=10.8 dB and SNR_{V}=6.8 dB.

When ΔSNR=±3 dB, SNR_{H}=11.8 dB and SNR_{V}=5.8 dB.

In this example, the ratio between IR_{H} and IR_{V} is changed while IR_{H}+IR_{V}=IRₜₒₜₐₗ remains fixed, so that ΔSNR is changed. When IR_{H}/(IR_{H}+IR_{V})=0.5, IR_{H}=IR_{V}, where information rates (IRs) are equally allocated between polarizations.

If IR_{H}/(IR_{H}+IR_{V})>0.5, IR_{H}>IR_{V}, a larger information rate (IR) is allocated to the H polarization than to the V polarization. If IR_{H}/(IR_{H}+IR_{V})<0.5, IR_{H}<IR_{V}, a larger information rate (IR) is allocated to the V polarization than to the H polarization.

When ΔSNR=±0 dB, NGMI is highest at the point where IR_{H}/(IR_{H}+IR_{V})=0.5. It may be seen that when there is no difference in SNR between polarizations, the transmission performance is best if IRs are equally allocated.

When ΔSNR=±1 dB, NGMI is highest around the point where IR_{H}/(IR_{H}+IR_{V})=0.55, and the transmission performance is best if a slightly larger IR is allocated to the H polarization.

When ΔSNR=±2 dB, the transmission performance increases if a still larger IR is allocated to the H polarization. When ΔSNR=±3 dB, NGMI improves by allocating a larger IR to the H polarization to the extent of the limit of the model currently assumed in a simulation, such that the effect of changing IRs may be obtained.

There is a lower limit of NGMI below which transmission may be made in an error free state because of the performance of FEC, and it is assumed that the total of NGMI of H polarization and NGMI of V polarization is larger than or equal to the lower limit (NGMIₜₒₜₐₗ≥NGMIₗᵢₘᵢₜ).

In many cases, the same information rate is set for the H polarization and the V polarization (IR_{H}/(IR_{H}+IR_{V})=0.5). This rate may be set as a default value. When there is a difference in transmission path characteristics for a signal of the H polarization and a signal of the V polarization due to PDL and so on, the SNRs are different between polarizations, which results in a difference in NGMI monitor value.

As in the embodiment, information rates (IRs) may be separately set for the H polarization and the V polarization, which enables the IR of each polarization to be changed while IRₜₒₜₐₗ remains fixed. However, adjustment of IR_{H} and IR_{V} is adjustment within the range of the IR of QAM symbols when probabilistic shaping is not applied.

By adjusting the ratio between IR_{H} and IR_{V} in accordance with a difference in NGMI value between polarizations, that is, the magnitude of a difference in SNR between polarizations, the NGMI that is used when a signal of the H polarization and a signal of the V polarization are combined by interleaving may be larger than before the adjustment. Setting the information rates (IRs) for increasing the NGMI value may enhance the transmission performance and increase the use efficiency of the bandwidth of each polarization. For example, the highest transmission efficiency is achieved by adjusting the IR of each polarization so as to substantially equalize the NGMI of the H polarization and the NGMI of the V polarization.

The characteristics in FIG. 7 are illustrative, and the relationships between index values, such as NGMI, and information rates (or the ratio therebetween) may be measured in advance in accordance with a difference between polarizations for each transmission path and stored in a suitable format, such as a table, chart, or function, in a memory of the optical communication apparatus 10. Such a memory may be provided inside a digital signal processing circuit at the transmitting end or at the receiving end or may be a memory shared by the digital signal processing circuits at the receiving end and at the transmitting end.

<Modification of Transmitting-End Digital Signal Processing Circuit>

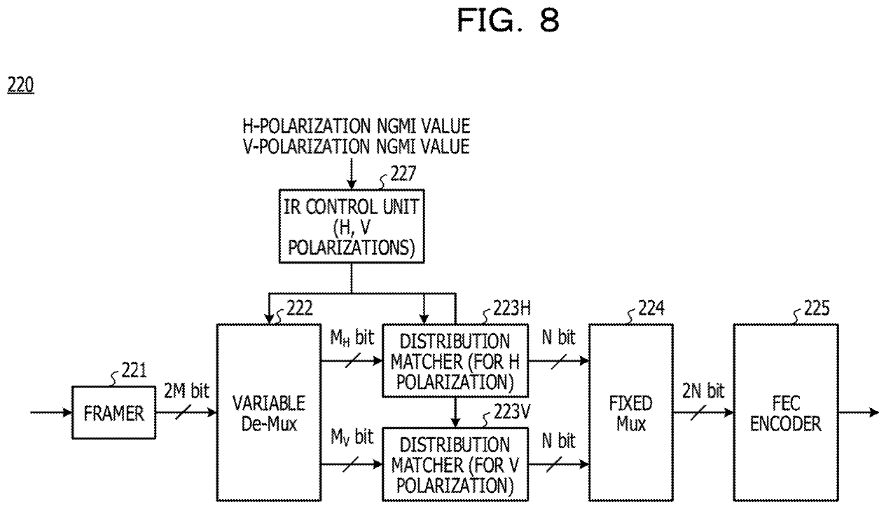

FIG. 8 is a block diagram of a transmitting-end digital signal processing circuit 220 as a modification. The transmitting-end digital signal processing circuit 220 includes a framer 221, a variable demultiplexer 222, an H-polarization distribution matcher 223H, a V-polarization distribution matcher 223V, a fixed multiplexer 224 with a fixed combination allocation ratio, an FEC encoder 225, and an IR control unit 227. The configuration after the FEC encoder 225 is the same as in the transmitting-end digital signal processing circuit 120 illustrated in FIG. 6.

The IR control unit 227 controls the separation ratio of the variable demultiplexer 222, and the H-polarization distribution matcher 223H and the V-polarization distribution matcher 223V, for example, based on the NGMI value of each polarization received from the receiving end. Assuming that the total number of frame-converted input bits is 2M, the IR control unit 227 changes an input block length (bit length) M_{H} of the H polarization and an input block length (bit length) M_{V} of the V polarization in accordance with the monitor values of NGMI of the respective polarizations while maintaining the total number of input bits of 2M (M_{H}+M_{H}=2M).

The outputs of the distribution matcher 223H and the distribution matcher 223V are fixed to N bits, and changing M_{H} and M_{V} only changes the conversion rates and does not affect processing of the fixed multiplexer 224 and the FEC encoder 225. The conversion rate of the H polarization is M_{H}/N, and the conversion rate of the V polarization is M_{V}/N. The variable demultiplexer 222 separates input bits in a ratio in accordance with the set values of M_{H} and M_{V}.

The distribution matchers 223 on the transmitter side and the distribution dematchers 117 on the receiver side (refer to FIG. 4) use the same values of M_{H} and M_{V} to perform conversion processes, and therefore the optical communication apparatus 10 as a communication partner is notified of newly set values of M_{H} and M_{V} (corresponding to information rates). For example, the values of M_{H} and M_{V} may be embedded in N bits of transmission data after conversion.

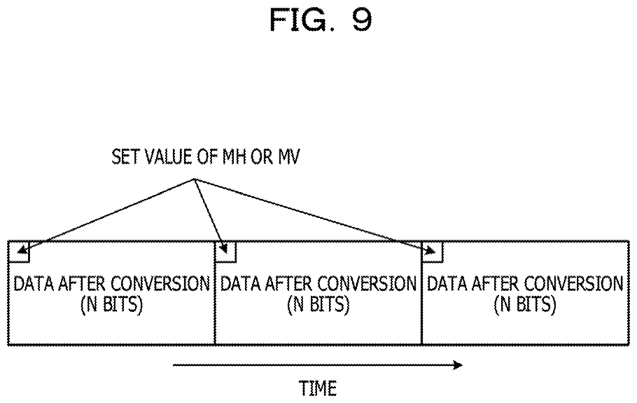

FIG. 9 is a schematic view of an output data format of the distribution matcher 223. Output data along the time axis is illustrated. In FIG. 9, the set value of M_{H} or M_{V} is embedded for every N bits for each polarization. However, this example is not limitative and the set values of M_{H} and M_{V} may be embedded at a suitable predetermined interval of an integral multiple of N. In this case, a frame ID in which the set values of M_{H} and M_{V} are embedded is also transmitted to the optical communication apparatus 10 on the partner side.

In the case of the modification, on the receiver side in FIG. 4, the set values of M_{H} and M_{V} are decoded by the FEC decoder 113, and the distribution dematcher 117H, the distribution dematcher 117V, and the variable multiplexer 118 are notified of the decoded set values of M_{H} and M_{V}.

Based on the conversion rates M_{H}/N and M_{V}/N of M_{H} and M_{V} of which the distribution dematcher 117H and the distribution dematcher 117V are notified, the distribution dematcher 117H and the distribution dematcher 117V restore the decoded signal of each polarization into a sequence of data bits in accordance with the information rate. The variable multiplexer 118 combines signals of the H polarization and the V polarization so as to be allocated in accordance with the ratio between M_{H} and M_{V}.

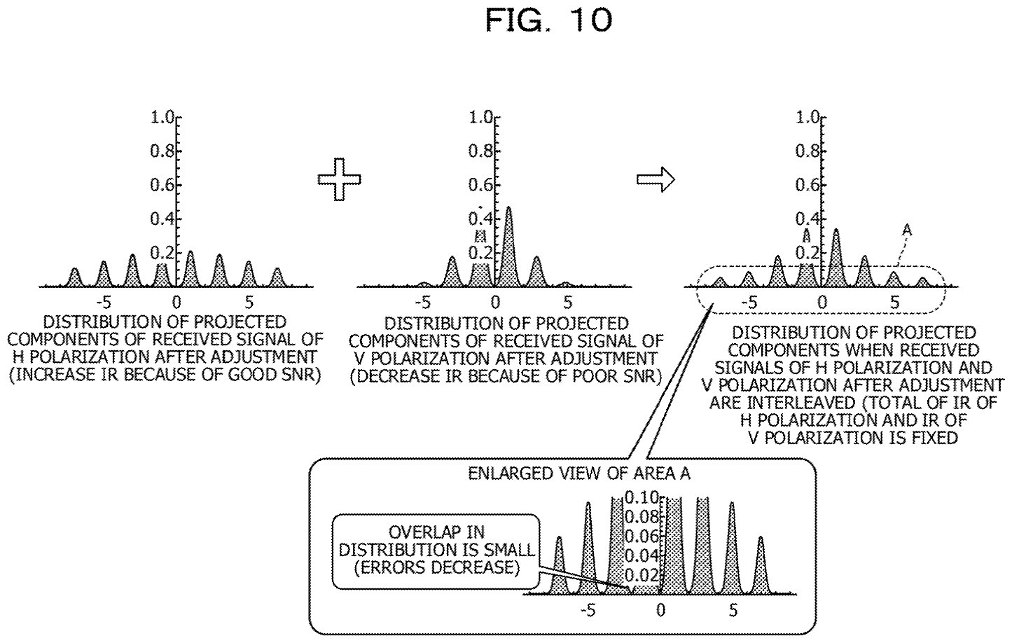

FIG. 10 is a diagram illustrating effects of a configuration of the embodiment. The probability distribution in the constellation is shaped in accordance with the monitor value of NGMI of each polarization. For example, when the SNR of a signal of the H polarization is good (the monitor value of NGMI is large), the change in the probability distribution of signal points on the constellation plane is decreased by increasing the information rate IR_{H} (by decreasing the degree of shaping). The variance in the distribution of projected components of the H polarization on the receiver side is small and the projected components are independent of each other, and thus the margin of the transmission path capacity is effectively utilized.

For the V polarization, the SNR of a received signal is poor, and therefore, by decreasing the information rate IR_{V} (by enhancing the degree of shaping), the probability distribution of signal points on the constellation plane is adjusted to a steeper Gaussian distribution centered around the origin. This may improve the SNR tolerance.

Interleaving the signal of the H polarization and the signal of the V polarization after the adjustment decreases the overlap of distributions at the base of the histogram while maintaining the information amount, thereby enabling errors on the receiver side to be reduced. By adjusting the IR for each polarization while maintaining the fixed total information rate IRₜₒₜₐₗ for the H polarization and the V polarization, the transmission performance may be enhanced only by the processing of a digital signal processor, without changing the baud rate of an optical signal itself.

The configuration of the embodiment is not limited not only to the effect of improving NGMI and the effect of reducing PDL but also has effects on improvement in other optical characteristics dependent on light polarization, such as the polarization extinction ratio (PER). The configuration of the embodiment also has improvement effects for unbalanced SNR degradation between polarizations due to electrical characteristics.

During operation, at fixed intervals or upon the occurrence of some event (such as the NGMI monitor value becoming less than or equal to a threshold) acting as a trigger, reflecting a monitor result of NGMI of the opposite optical communication apparatus 10 allows a change in SNR, which changes over time, to be dealt with.

<First Option>

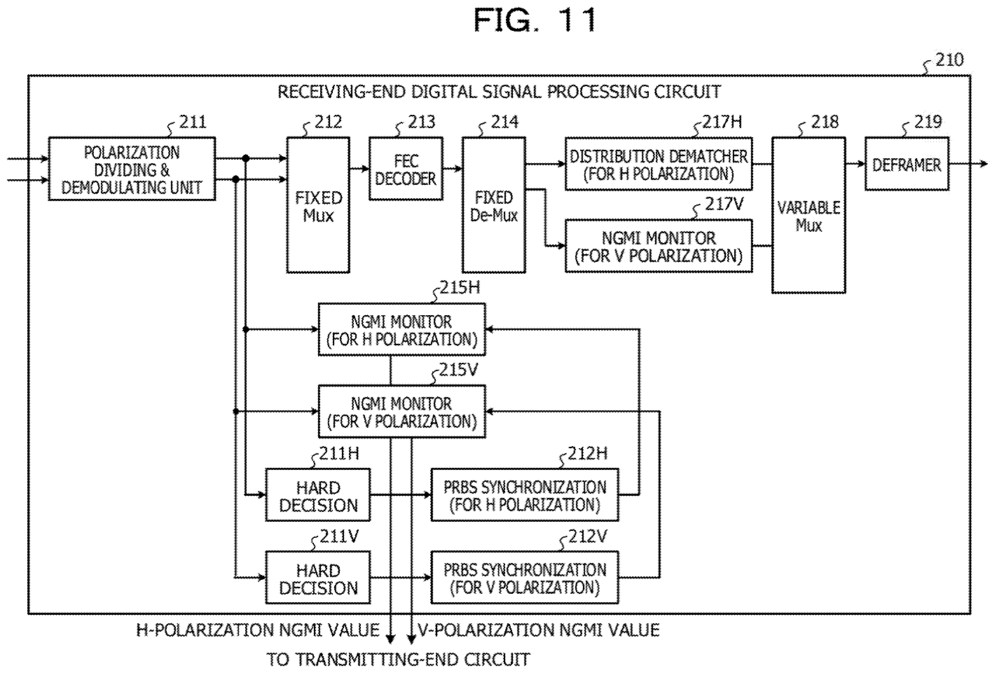

FIG. 11 illustrates the receiving-end digital signal processing circuit 210 of a first option of the embodiment. During non-operation, such as upon initial coupling and during maintenance inspection, when a known test signal, such as a pseudorandom binary sequence (PRBS), is used, detection data of the known signal, instead of output of an FEC decoder, may be used as expected data.

The operations of the polarization dividing and demodulating unit 211, the fixed multiplexer 212, the FEC decoder 213, the fixed demultiplexer 214, the distribution dematchers 217H and 217V, the variable multiplexer 218, and the deframer 219 are the same as the operations of the corresponding functional blocks in FIG. 4, and repetitive description is omitted.

A signal of the H polarization and a signal of the V polarization divided and demodulated by the polarization dividing and demodulating unit 211 are input to the NGMI monitor 215H and the NGMI monitor 215V, respectively, and are also input to a hard decision circuit 211H and a hard decision circuit 211V, respectively.

The hard decision circuit 211H makes a hard decision of the signal of the H polarization as a sequence of bits in which the values are binarized to either “0” or “1”. The hard decision circuit 211V makes a hard decision of the signal of the V polarization as a sequence of bits in which the values are binarized to either “0” or “1”.

A PRBS synchronization circuit 212H compares the sequence of bits of the H polarization obtained by the hard decision with the sequence of bits of known synchronization words (PRBS) to measure the bit correlation. When the bit correlation is greater than a predetermined threshold (for example, when the number of matched bits is greater than the threshold), it is determined that synchronization is accomplished, and the synchronized PRBS sequence is coupled to the input at the other end of the NGMI monitor 215H. This synchronized sequence may be regarded as expected data that matches the transmission PRBS.

A PRBS synchronization circuit 212V compares the sequence of bits of the V polarization obtained by the hard decision with the sequence of bits of known synchronization words (PRBS) to measure the bit correlation. When the bit correlation is greater than a predetermined threshold (for example, the number of matched bits is greater than the threshold), it is determined that synchronization is accomplished, and the synchronized PRBS sequence is coupled to the input at the other end of the NGMI monitor 215V. This synchronized sequence may be regarded as expected data that matches the transmission PRBS.

As described with reference to FIG. 5, each of the NGMI monitor 215H and the NGMI monitor 215V calculates and outputs NGMI of the respective polarization based on two inputs, that is, a demodulated received-bit log likelihood ratio (LLR) and expected data of a known signal the hard decision of which has been made. The output NGMI monitor values of the H polarization and the V polarization may be transferred to a transmitting-end circuit to be transmitted on an optical transmission path to the optical communication apparatus 10 as the coupling partner or may be transmitted to a control device on a network.

The IR control unit 227 in the transmitting-end digital signal processing circuit of the optical communication apparatus 10 as the coupling partner (refer to FIG. 8) or the control device on a network adjusts the ratio between information rates of the H polarization and the V polarization so as to optimize the NGMI value based on the NGMI monitor value of each polarization. The information rate IR of the polarization with a low NGMI value is decreased, and the information rate IR of the polarization with a high NGMI value is increased.

With this configuration, during non-operation, the state of the transmission path at that time is reflected to optimize the transmission performance for each polarization, such that the use efficiency of the bandwidth of each polarization may be increased.

<Second Option>

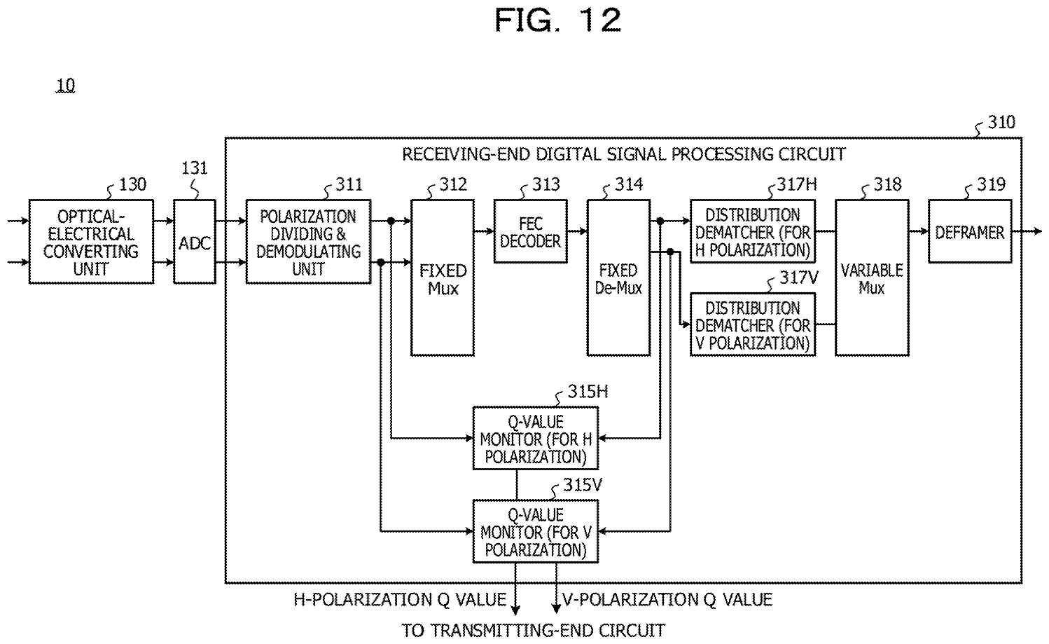

FIG. 12 illustrates a receiving-end digital signal processing circuit 310 of a second option of the embodiment. In the second option, instead of NGMI, a Q value or Pre-FEC BER is monitored as an index of decoding performance.

The receiving-end digital signal processing circuit 310 includes a Q-value monitor 315H and a Q-value monitor 315V, instead of the H-polarization NGMI monitor 115H and the V-polarization NGMI monitor 115V of the receiving-end digital signal processing circuit 110 in FIG. 4.

One input of the H-polarization Q-value monitor 315H receives the log likelihood ratio (LLR) of received bits of the H polarization that are divided and demodulated by the polarization dividing and demodulating unit 311, and the other input receives expected data (transmission bits) of the H polarization that has been subjected to error correction decoding by the FEC decoder 313 and divided according to a fixed allocation ratio by the fixed demultiplexer 314.

The Q-value monitor 315H calculates the Q value of the H polarization based on the received data and the expected data (transmission data) and outputs the calculated Q value.

One input of the V-polarization Q-value monitor 315V receives the log likelihood ratio (LLR) of received bits of the V polarization that are divided and demodulated by the polarization dividing and demodulating unit 311, and the other input receives expected data (transmission bits) of the H polarization that has been subjected to error correction decoding by the FEC decoder 313 and divided according to a fixed allocation ratio by the fixed demultiplexer 314.

The Q-value monitor 315V calculates the Q value of the V polarization based on the received data and the expected data (transmission data) and outputs the calculated Q value.

The Q value is a value obtained by dividing the amplitude of received data (energy stored in the system in one modulation) by a variation in the amplitude of received bits (energy deviated from the system). The larger the variation in the amplitude of received bits, the lower the Q value, which means a decrease in signal quality.

The output Q value of each polarization is transferred to a transmitting-end circuit and may be fed to the optical communication apparatus 10 on the partner side on the optical transmission path 2 or 3 or may be fed to a control device on an optical network.

In the case where Pre-FEC BER is used as an index for composite performance, a bit error rate prior to decoding that is output by the FEC decoder 313 is used.

The IR control unit 227 in the transmitting-end digital signal processing circuit of the optical communication apparatus 10 on the partner side (refer to FIG. 8) or the control device on a network adjusts the ratio between information rates of the H polarization and the V polarization so as to optimize the Q value, based on the Q value of each polarization. For example, the information rate IR of the polarization with a low Q value is decreased, and the information rate IR of the polarization with a high Q value is increased. This may improve the transmission performance to enhance the use efficiency of the bandwidth of each polarization.

<Third Option>

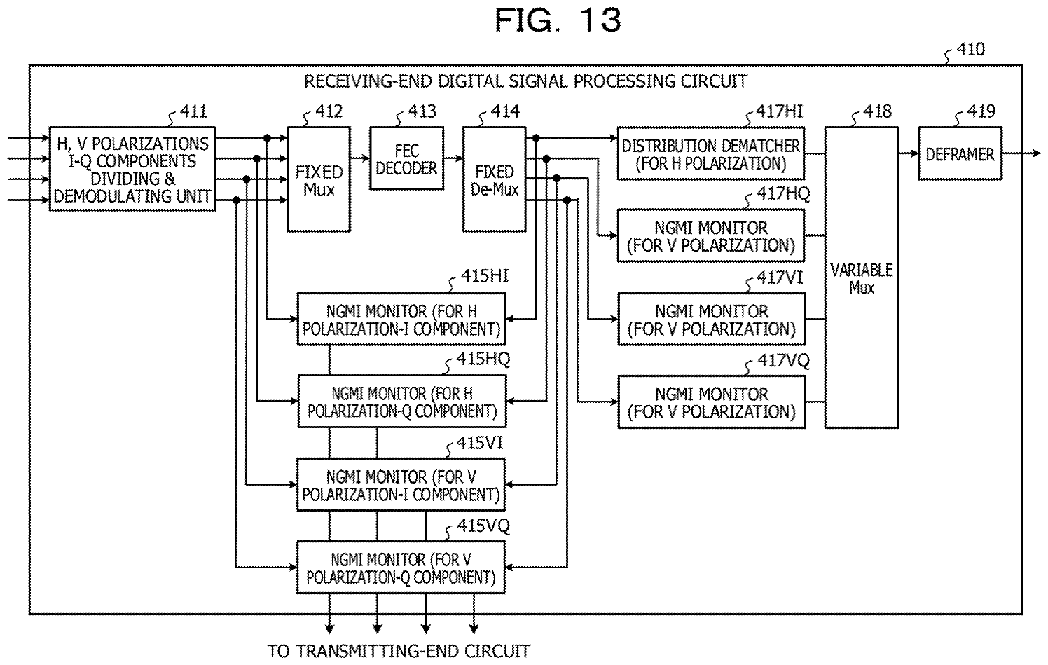

FIG. 13 illustrates a receiving-end digital signal processing circuit 410 of a third option of the embodiment. In the third option, PS is set in such a manner that not only the H polarization and the V polarization but also the I-axis and the Q-axis are distinguished from each other and monitored. In this case, the optical-electrical converting unit 130 in FIG. 4 detects the I-axis component and the Q-axis component for the H polarization and the V polarization, for example, by using a 90° hybrid optical mixer, and the ADC 131 performs digital sampling of each of the four detected analog outputs.

The receiving-end digital signal processing circuit 410 includes four NGMI monitors 415HI, 415HQ, 415VI, and 415VQ and four distribution dematchers 417HI, 417HQ, 417VI, and 417VQ.

An H, V polarizations I-Q components dividing and demodulating unit 411 divides an H-polarization I component, an H-polarization Q component, a V-polarization I component, and V-polarization Q component from an input digital signal and demodulates the components, and feeds the modulated components to a fixed multiplexer 412 and inputs the components respectively to NGMI monitors 415HI, 415HQ, 415VI, and 415VQ.

The fixed multiplexer 412 combines the input H-polarization I component, H-polarization Q component, V-polarization I component, V-polarization Q component according to a fixed allocation ratio, subjects the resultant signal to error correction decoding with the FEC decoder 413, and feeds the decoded signal to a fixed demultiplexer 414.

The fixed demultiplexer 414 separates the decoded signal according to a fixed allocation ratio into the H-polarization I component, the H-polarization Q component, the V-polarization I component, and the V-polarization Q component, and the respective decoded components are input to the corresponding distribution dematchers 417HI, 417HQ, 417VI, and 417VQ. The respective decoded components are also fed to the other input terminals of the NGMI monitors 415HI, 415HQ, 415VI, and 415VQ.

Based on the received data of respective demodulated components and expected data (transmission data) after error correction decoding, the NGMI monitors 415HI, 415HQ, 415VI, and 415VQ calculate and output the NGMI of the respective components.

Meanwhile, data of the respective components that have been subjected to error correction decoding are restored to the sequences of data bits according the allocated information rates by the corresponding distribution dematchers 417HI, 417HQ, 417VI, and 417VQ. These sequences of data bits are multiplexed according to a variable allocation ratio by a variable multiplexer 418 and are converted into the frame format of the client side by the deframer 419.

With this configuration, NGMI is monitored for each component detected by the optical-electrical converting unit and optimum PS is set for each of four components, which may improve the transmission performance and utilize each polarization bandwidth as much as possible.

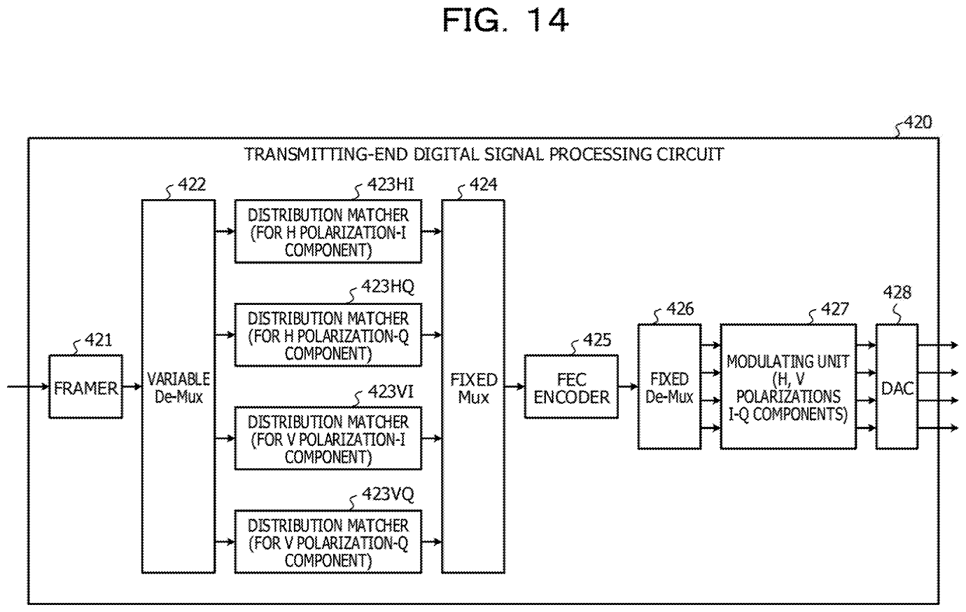

FIG. 14 is a block diagram of a transmitting-end digital signal processing circuit 420 corresponding to the configuration in FIG. 13. In the transmitting-end digital signal processing circuit 420, four distribution matchers 423HI, 423HQ, 423VI, and 423VQ are provided between a variable demultiplexer 422 and a fixed multiplexer 424.

A signal converted from a frame format of the client side to a frame format of the network side by a framer is separated into an H-polarization I component, an H-polarization Q component, a V-polarization I component, and a V-polarization Q component according to a variable bit allocation ratio by the variable demultiplexer 422.

In the distribution matchers 423HI, 423HQ, 423VI, and 423VQ, to which the NGMI monitor values or IR percentages of the respectively corresponding components are supplied, the shaping degrees of PS are adjusted in accordance with the NGMI monitor values or IR percentages.

The IR percentages of the components may be, for example, represented as (IR_{HI}/(IR_{HI}+IR_{HQ}+IR_{VI}+IR_{VQ})), (IR_{HQ}/(IR_{HI}+IR_{HQ}+IR_{VI}+IR_{VQ})), (IR_{VI}/(IR_{HI}+IR_{HQ}+IR_{VI}+IR_{VQ})), and (IR_{V}a(IR_{HI}+IR_{HQ}+IR_{VI}+IR_{VQ})). When the NGMI monitor value is large and the SNR or the transmission state is good, a large IR percentage is set. When the NGMI monitor value is small and the SNR or the transmission state is poor, the IR percentage is set to a small value, so that the degree of shaping is increased.

In the case where the IR percentages themselves are input to the distribution matchers 423HI, 423HQ, 423VI, and 423VQ, based on the NGMI monitor values of the components received from the communication partner side, the IR percentages may be calculated with this optical communication apparatus 10 or may be calculated on a network. Likewise as illustrated in FIG. 8, an IR control unit that controls IRs set for the variable demultiplexer 422 and four distribution matchers 423HI, 423HQ, 423VI, and 423VQ may be provided. In this case, a configuration in which K_{HI}, K_{HQ}, K_{VI}, and K_{VQ} are changed according to the IR percentages while the bit length of an input block is kept fixed to K_{HI}+K_{HQ}+K_{VI}+K_{VQ}=4K may be employed.

The operations of the fixed multiplexer 424, an FEC encoder 425, a fixed demultiplexer 426, a modulating unit 427, and a DAC 428 are similar to the operations of components illustrated in FIG. 8, except that the number of components to be separated is four. Since the output of each of the distribution matchers 423HI, 423HQ, 423VI, and 423VQ is fixed to N bits, changing k bit length has no influence on the subsequent processes.

With the configuration of the third option, the information rate or probability distribution is shaped to be optimal for each polarization and for each phase component to be multiplexed, such that improvement in transmission performance and useful usage of bandwidths are achieved.

Although the disclosure has been described above based on the specific embodiments, the disclosure is not limited to the above embodiments. For example, instead of the configuration in which while the total information rate of the H polarization and the V polarization is fixed, the information rate of each polarization is adjusted, a configuration in which the information rate for each polarization is adjusted in accordance with the quality or state of the actual transmission path, while the total information rate IRₜₒₜₐₗ is controlled optimally, may be employed. In this case, on the receiver side, not only information rate of each polarization after control but also the total information rate IRₜₒₜₐₗ may be shared.

An optical communication apparatus may be configure to be switchable between input of an expected value to an NGMI monitor during non-operation (FIG. 11) and input of an expected value to an NGMI monitor during operation (FIG. 4 and so on). Such an optical communication apparatus may be switchable such that, during non-operation, the detection value of a known signal obtained by a hard decision may be coupled as expected data of each polarization to the other input of the NGMI monitor whereas, during operation, the output of an FEC decoder is coupled as expected data to the other input of the NGMI monitor.

The feedback mechanism of the monitor value of NGMI to the transmitter side may be configured to transmit the monitor value from the DSP of the transmitter end to the optical communication apparatus 10 on the partner side via an optical transmission path, or may be configured to notify a control device on a network via a network interface to provide an instruction of an information rate ratio and the like from the control device to the optical communication apparatus 10 on the partner side. In the case where the optical communication apparatus 10 on the partner side is directly notified on an optical transmission path, the notification may be embedded in a data signal and transmitted or may be carried overhead or on SV light.

Two or more among the basic configuration and the first to third options may be combined. In the receiving-end digital signal processing circuits 210, 310, and 410 of the first to third options, a control unit that notifies the IR percentage or conversion ratio (M/N) of components set on the transmitter side may be provided in each distribution dematcher and variable demultiplexer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical communication apparatus comprising:
a first monitor that monitors a first signal carried on a first polarization and outputs a first monitor value representing a transmission characteristic of the first signal;
a second monitor that monitors a second signal carried on a second polarization orthogonal to the first polarization and outputs a second monitor value representing a transmission characteristic of the second signal; and
a transmitting circuit that notifies a transmitting source of the first signal and the second signal of the first monitor value and the second monitor value.

2. The optical communication apparatus according to claim 1, wherein
the first monitor outputs the first monitor value based on a received bit of the first signal before being subjected to error correction decoding and expected data of the first signal after being subjected to the error correction decoding, and
the second monitor outputs the second monitor value based on a received bit of the second signal before being subjected to the error correction decoding and expected data of the second signal after being subjected to the error correction decoding.

3. The optical communication apparatus according to claim 1, further comprising:
a decoder that applies error correction decoding to the first signal and the second signal;
a first dematcher that restores the first signal after being subjected to the error correction decoding to a first data bit sequence of a first information amount that reflects the first monitor value and is allocated to the first signal; and
a second dematcher that restores the second signal after being subjected to the error correction decoding to a second data bit sequence of a second information amount that reflects the second monitor value and is allocated to the second signal.

4. The optical communication apparatus according to claim 1, wherein
during non-operation, the optical communication apparatus receives a known signal,
the first monitor outputs the first monitor value based on a received bit of a first component before being subjected to the error correction decoding of the known signal and a hard decision result of the first component, and
the second monitor outputs the second monitor value based on a received bit of a second component before being subjected to the error correction decoding of the known signal and a hard decision result of the second component.

5. The optical communication apparatus according to claim 1, wherein
the first monitor monitors an in-phase component of the first signal and outputs the first monitor value, and
the second monitor monitors an in-phase component of the second signal and outputs the second monitor value,
the optical communication apparatus further comprising:
a third monitor that monitors a quadrature-phase component of the first signal and outputs a third monitor value; and
a fourth monitor that monitors a quadrature-phase component of the second signal and outputs a fourth monitor value (NGMI_{VQ}).

6. The optical communication apparatus according to claim 1, wherein the first monitor value is first normalized generalized mutual information in the first signal and the second monitor value is second normalized generalized mutual information in the second signal.

7. An optical communication apparatus comprising:
a first matcher that applies first shaping to a probability distribution in a constellation of a first signal carried on the first polarization, in accordance with a difference in transmission characteristic between the first polarization and the second polarization that are orthogonal to each other; and
a second matcher that applies second shaping to a probability distribution in a constellation of a second signal carried on the second polarization, in accordance with the difference in transmission characteristic.

8. The optical communication apparatus according to claim 7, further comprising:
a control circuit that sets a first information rate allocated to the first signal and a second information rate allocated to the second signal, in accordance with the difference in transmission characteristic,
wherein the first matcher applies the first shaping according to the first information rate, and
wherein the second matcher applies the second shaping according to the second information rate.

9. The optical communication apparatus according to claim 8, wherein the control circuit maintains a fixed total information rate of the first information rate and the second information rate and changes the first information rate and the second information rate.

10. The optical communication apparatus according to claim 8, further comprising:
a variable demultiplexer that separates a transmission bit sequence according to the first information rate and the second information rate,
wherein a first bit sequence and a second bit sequence separated by the variable demultiplexer are input to the first matcher and the second matcher, respectively.

11. The optical communication apparatus according to claim 7, wherein the difference in transmission characteristic between the first polarization and the second polarization is represented by monitor information fed back from an apparatus as a communication partner or a network.

12. An optical transmission system comprising:
a first optical communication apparatus; and
a second optical communication apparatus coupled to the first optical communication apparatus by an optical transmission path, wherein
in the second optical communication apparatus, a first transmission characteristic of a received signal of a first polarization and a second transmission characteristic of a received signal of a second polarization orthogonal to the first polarization are monitored, and
based on a monitor result obtained in the second optical communication apparatus, the first optical communication apparatus shapes a probability distribution in a constellation of a first signal transmitted on the first polarization and a probability distribution in a constellation of a second signal transmitted on the second polarization.

13. The optical transmission system according to claim 12, wherein
the second optical communication apparatus notifies the first optical communication apparatus of a first monitor value representing the first transmission characteristic and a second monitor value representing the second transmission characteristic via the optical transmission path, and
the first optical communication apparatus performs the shaping in accordance with the first monitor value and the second monitor value.

14. The optical transmission system according to claim 13, wherein, based on the first monitor value and the second monitor value, the second optical communication apparatus changes a first information rate allocated to the first signal and a second information rate allocated to the second signal while maintaining a fixed total information amount of the first signal and the second signal.

15. The optical transmission system according to claim 12, wherein
the second optical communication apparatus notifies a control device on a network of a first monitor value representing the first transmission characteristic and a second monitor value representing the second transmission characteristic, and
the first optical communication apparatus receives a first information rate allocated to the first signal and a second information rate allocated to the second signal from the control device and performs the shaping according to the first information rate and the second information rate.

16. An optical communication method comprising:
in an optical communication apparatus,
monitoring a first received signal carried on a first polarization and outputting a first monitor value representing a transmission characteristic of the first received signal;
monitoring a second received signal carried on a second polarization orthogonal to the first polarization and outputting a second monitor value representing a transmission characteristic of the second received signal; and
feeding back information represented by the first monitor value and the second monitor value to an apparatus as a communication partner.

17. The optical communication method according to claim 16, wherein
the first monitor value is generated based on the first received signal before being subjected to error correction decoding and expected data of the first received signal after being subjected to the error correction decoding, and
the second monitor value is generated based on the second received signal before being subjected to the error correction decoding and expected data of the second received signal after being subjected to the error correction decoding.

18. An optical communication method comprising:
in an optical communication apparatus,
applying first shaping to a probability distribution in a constellation of a first signal carried on a first polarization, in accordance with a difference in transmission characteristic between the first polarization and a second polarization that are orthogonal to each other; and
applying second shaping to a probability distribution in a constellation of a second signal carried on the second polarization, in accordance with the difference in transmission characteristic.

19. The optical communication method according to claim 18, wherein
a first information rate allocated to the first signal and a second information rate allocated to the second signal are set in accordance with the difference in transmission characteristic,
the first shaping is applied according to the first information rate, and
the second shaping is applied according to the second information rate.

20. The optical communication method according to claim 19, wherein while a fixed total information rate of the first information rate and the second information rate is maintained, the first information rate and the second information rate are changed.
